(19) United States
(12) Patent Application Publication
(10) Pub. No.: US 2017/0297134 A1
(43) Pub. Date: Oct. 19, 2017

(54) RESISTANCE SPOT WELDING ALUMINUM TO STEEL USING PREPLACED METALLURGICAL ADDITIVES

(71) Applicant: GM GLOBAL TECHNOLOGY OPERATIONS LLC, DETROIT, MI (US)

(72) Inventors: David R. Sigler, Shelby Township, MI (US); Thomas A. Perry, Bruce Township, MI (US); James G. Schroth, Troy, MI (US)

(21) Appl. No.: 15/491,484

(22) Filed: Apr. 19, 2017

Related U.S. Application Data
(60) Provisional application No. 62/324,688, filed on Apr. 19, 2016.

(51) Int. Cl. B23K 11/11; B23K 11/20; B23K 11/34; B23K 35/00

(52) U.S. Cl. CPC B23K 11/115; B23K 35/002; B23K 11/20; B23K 11/34

(57) ABSTRACT

A method of resistance spot welding a workpiece stack-up that that includes an aluminum workpiece and an adjacent overlapping steel workpiece involves assembling the workpiece stack-up so that an intermediate metallurgical additive is positioned between the faying surfaces of the aluminum and steel workpieces. The intermediate metallurgical additive includes at least one of carbon, silicon, nickel, manganese, chromium, cobalt, or copper, and has the capability to counteract the growth and formation of Fe—Al intermetallic compounds within a molten metal weld pool created within the aluminum workpiece during resistance spot welding of the workpiece stack-up. In certain aspects of the disclosed method, the intermediate metallurgical additive may be one or more metallurgical additive deposits that are deposited onto the faying surface of the aluminum workpiece or the faying surface of the steel workpiece by an oscillating wire arc welding process.

### CROSS-REFERENCE TO RELATED APPLICATION(S)

This application claims the benefit of U.S. Provisional Application No. 62/324,688 filed on Apr. 19, 2016. The entire contents of the aforementioned provisional application are incorporated herein by reference.

### TECHNICAL FIELD

The technical field of this disclosure relates generally to a method for resistance spot welding an aluminum workpiece and a steel workpiece with the assistance of a pre-placed metallurgical additive that, during welding, interacts with the molten aluminum weld pool created within the aluminum workpiece to counteract the growth of a Fe—Al intermetallic layer.

### INTRODUCTION

Resistance spot welding is a process used by a number of industries to join together two or more metal workpieces. The automotive industry, for example, often uses resistance spot welding to join together metal workpieces during the manufacture of vehicle structural members (e.g., body sides and cross members) and vehicle closure members (e.g., doors, hoods, trunk lids, or lift gates), among others. A number of spot welds are typically formed along a peripheral edge of the metal workpieces or some other bonding region to ensure the part is structurally sound. And while spot welding has traditionally been practiced to join together certain similarly-composed metal workpieces—such as steel-to-steel and aluminum alloy-to-aluminum alloy—the desire to incorporate lighter weight materials into a vehicle body structure has generated interest in joining an aluminum alloy workpiece to a steel workpiece by resistance spot welding. Other manufacturing industries including the aviation, maritime, railway, and building construction industries are also interested in developing effective and repeatable procedures for joining such dissimilar metal workpieces.

Resistance spot welding relies on the resistance to the flow of an electrical current through overlapping metal workpieces and across their faying interface(s) to generate heat. To carry out such a welding process, a set of opposed and facially aligned welding electrodes is clamped at aligned spots on opposite sides of the workpiece stack-up, which typically includes two to four metal workpieces arranged in lapped configuration. An electrical current is then passed through the metal workpieces from one welding electrode to the other. Resistance to the flow of this electrical current generates heat within the metal workpieces and at their faying interface(s). When the workpiece stack-up includes an aluminum workpiece and an adjacent steel workpiece, the heat generated at the faying interface and within the bulk material of those dissimilar metal workpieces initiates and grows a molten aluminum weld pool within the aluminum workpiece. This molten aluminum weld pool wets the adjacent faying surface of the steel workpiece and, upon termination of the current flow, solidifies into a weld joint that weld bonds the two dissimilar workpieces together.

In practice, however, spot welding an aluminum workpiece to a steel workpiece is challenging since a number of characteristics of those two metals can adversely affect the strength—most notably the strength in peel and cross-tension—of the weld joint. For one, the aluminum workpiece usually contains a mechanically tough, electrically insulating, and self-healing refractory oxide surface layer. The oxide surface layer is typically comprised of aluminum oxide compounds, although other oxide compound may also be present such as, for example, magnesium oxide compounds when the aluminum workpiece contains a magnesium-containing aluminum alloy. As a result of its physical properties, the refractory oxide layer has a tendency to remain intact at the faying interface of the aluminum and steel workpieces where it not only hinders the ability of the molten aluminum weld pool to wet the steel workpiece, but also provides a source of near-interface defects. Furthermore, the insulating nature of the refractory oxide surface layer raises the electrical contact resistance of the aluminum workpiece—namely, at its faying surface and at its electrode contact point—making it difficult to effectively control and concentrate heat within the aluminum workpiece.

Apart from the challenges presented by the refractory oxide surface layer of the aluminum workpiece, the aluminum workpiece and the steel workpiece possess different properties that can adversely affect the strength and properties of the weld joint. Specifically, aluminum has a relatively low melting temperature range and relatively low electrical and thermal resistivities, while steel has a relatively high melting temperature range and relatively high electrical and thermal resistivities. As a consequence of these differences in material properties, most of the heat is generated in the steel workpiece during current flow such that a heat imbalance exists between the steel workpiece (higher temperature) and the aluminum workpiece (lower temperature). The combination of the heat imbalance created during current flow and the high thermal conductivity of the aluminum workpiece means that, immediately after the electrical current ceases, a situation occurs where heat is not disseminated symmetrically from the weld site. Instead, heat is conducted from the hotter steel workpiece through the aluminum workpiece towards the welding electrode on the other side of the aluminum workpiece, which creates a steep thermal gradient in that direction.

The development of a steep thermal gradient between the steel workpiece and the welding electrode on the other side of the aluminum workpiece is believed to weaken the resultant weld joint in several ways. First, because the steel workpiece retains heat for a longer duration than the aluminum workpiece after flow of electrical current has terminated, the molten aluminum weld pool solidifies directionally, starting from the region nearest the colder welding electrode (often water cooled) proximate the aluminum workpiece and propagating towards the faying interface. A solidification front of this kind tends to sweep or drive defects—such as gas porosity, shrinkage voids, and micro-cracking—towards and along the bonding interface of the weld joint and the steel workpiece where residual oxide film residue defects are already present. The residual oxide film defects can be particularly disruptive if combined with thermal decomposition residuals from either an adhesive layer or other organic material layer that may be present between the aluminum and steel workpieces. Second, the sustained elevated temperature in the steel workpiece promotes the growth of a hard and brittle Fe—Al intermetallic layer within the weld joint contiguous with the adjacent faying surface of the steel workpiece. Having a dispersion of weld defects together with excessive growth of the Fe—Al intermetallic layer tends to reduce the peel and cross-tension strength of the weld joint.

In light of the aforementioned challenges, previous efforts to spot weld an aluminum workpiece and a steel workpiece have employed a weld schedule that specifies higher currents, longer weld times, or both (as compared to spot welding steel-to-steel), in order to try and obtain a reasonable weld bond area. Such efforts have been largely unsuccessful in a manufacturing setting and have a tendency to damage the welding electrodes. Given that previous spot welding efforts have not been particularly successful, mechanical fasteners such as self-piercing rivets and flow-drill screws have predominantly been used instead. Mechanical fasteners, however, take longer to put in place and have high consumable costs compared to spot welding. They also add weight to the vehicle—weight that is avoided when joining is accomplished by way of spot welding—that offsets some of the weight savings attained through the use of aluminum workpieces in the first place. Advancements in spot welding that would make the process more capable of joining aluminum and steel workpieces would thus be a welcome addition to the art.

### SUMMARY

A method of resistance spot welding a workpiece stack-up that that includes an aluminum workpiece and an adjacent overlapping steel workpiece according to one embodiment of the present disclosure may include several steps. First, a workpiece stack-up is assembled that includes an aluminum workpiece and an overlapping adjacent steel workpiece in which a faying surface of the aluminum workpiece and a faying surface of the steel workpiece confront to establish a faying interface of the aluminum and steel workpieces. The workpiece stack-up further includes an intermediate metallurgical additive positioned between the faying surfaces of the aluminum and steel workpieces. The intermediate metallurgical additive comprises at least one of carbon, silicon, nickel, manganese, chromium, cobalt, or copper. In another step, a weld face of a first welding electrode is pressed against an aluminum workpiece surface that provides a first side of the workpiece stack-up, and a weld face of a second welding electrode is pressed against a steel workpiece surface that provides a second side of the workpiece stack-up. In still another step, an electrical current is passed through the workpiece stack-up and between the weld faces of the first and second welding electrodes to create a molten aluminum weld pool within the workpiece stack-up. The molten aluminum weld pool is exposed to the intermediate metallurgical additive so as to counteract growth and formation of Fe—Al intermetallic compounds within the molten aluminum weld pool. In yet another step, the passage of the electrical current is terminated to allow the molten aluminum weld pool to solidify into a weld joint that weld bonds the aluminum and steel workpieces together.

The aforementioned embodiment of the disclosed method may include additional steps and/or be further defined. For example, the intermediate metallurgical additive may be a ferrous alloy that includes at least one of carbon silicon, nickel, manganese, chromium, cobalt, or copper. In particular, the intermediate metallurgical additive may be a ferrous alloy that includes at least one of 0.050 wt % carbon to 1.0 wt % carbon, 0.1 wt % to 10 wt % silicon, 0.5 wt % to 20 wt % nickel, 0.5 wt % to 30 wt % manganese, 0.5 wt % to 20 wt % chromium, or 0.5 wt % to 50 wt % cobalt. The intermediate metallurgical additive may also be unalloyed nickel, unalloyed copper, or an alloy rich in nickel or copper. If composed in this way, a layer of intermetallic compounds may be produced at a bonding interface of the weld joint and the faying surface of the steel workpiece or a surface of the intermediate metallurgical additive. This layer of intermetallic compounds may include Ni—Al intermetallic compounds or Cu—Al intermetallic compounds. As another variation, the intermediate metallurgical additive may comprise one or more metallurgical additive deposits deposited onto the faying surface of the aluminum workpiece or the faying surface of the steel workpiece by oscillation wire arc welding.

The deposition of each of the one or more metallurgical additive deposits onto the faying surface of the aluminum workpiece or the faying surface of the steel workpiece by oscillating wire arc welding may be further defined by various steps. In one step, a leading tip end of a consumable electrode rod, which is comprised of a metallurgical additive composition, is brought into contact with the faying surface of the aluminum workpiece or the faying surface of steel workpiece. Next, an electrical current is passed through the consumable electrode rod while the leading tip end of the consumable electrode rod is in contact with the faying surface of the aluminum workpiece or the faying surface of the steel workpiece. The consumable electrode rod is then retracted away from the faying surface of the aluminum workpiece or the faying surface of the steel workpiece to thereby strike an arc across a gap formed between the consumable electrode rod and the faying surface of the aluminum workpiece or the faying surface of the steel workpiece. The arc initiated melting of the leading tip end of the consumable electrode rod. Next, the consumable electrode rod is protracted forward to close the gap and bring a molten metallurgical additive droplet that has formed at the leading tip end of the electrode rod into contact with the faying surface of the aluminum workpiece or the faying surface of the steel workpiece. The contact between the molten metallurgical additive droplet and the faying surface of the aluminum workpiece or the faying surface of the steel workpiece extinguishes the arc. Once that happens, the consumable electrode rod is retracted away from the faying surface of the aluminum workpiece or the faying surface of the steel workpiece to transfer the molten metallurgical additive droplet from the leading tip end of the consumable electrode rod to the faying surface of the aluminum workpiece or the faying surface of the steel workpiece. The molten metallurgical additive droplet transferred to the faying surface of the aluminum workpiece or the faying surface of the steel workpiece eventually solidifies into all or part of a metallurgical additive deposit. These several steps may be repeated one or more times to transfer multiple metallurgical additive droplets to the faying surface of the aluminum workpiece or the faying surface of the steel workpiece such that the multiple metallurgical additive droplets combine and solidify into the metallurgical additive deposit.

Other variations of the aforementioned method of the disclosed method are also possible. In one such instance, the aluminum workpiece includes an exposed back surface that constitutes the aluminum workpiece surface that provides the first side of the workpiece stack-up, and the steel workpiece includes an exposed back surface that constitutes the steel workpiece surface that provides the second side of the workpiece stack-up. Alternatively, the workpiece stack-up includes at least one of: (1) an additional aluminum workpiece that overlaps the aluminum and steel workpieces and lies adjacent to the aluminum workpiece or (2) an additional steel workpiece that overlaps the aluminum and steel workpieces and lies adjacent to the steel workpiece. As another example, a layer of intermetallic compounds may be produced at a bonding interface of the weld joint and the faying surface of the steel workpiece or a surface of the intermediate metallurgical additive. This layer of intermetallic compounds may include Fe—Al intermetallic compounds and is less than 3 μm in thickness. Still further, the aluminum workpiece may include an aluminum substrate composed of an aluminum alloy having a refractory oxide surface layer and the steel workpiece may include a coated or uncoated steel substrate composed of mild steel, dual phase steel, or boron steel.

A method of resistance spot welding a workpiece stack-up that that includes an aluminum workpiece and an adjacent overlapping steel workpiece according to another embodiment of the present disclosure may include several steps. In one step, a metallurgical additive deposit is deposited onto a faying surface of an aluminum workpiece such that the metallurgical additive deposit is adhered to the faying surface of the aluminum workpiece. The metallurgical additive deposit is a metal that comprises at least one of carbon, silicon, nickel, manganese, chromium, cobalt, or copper. In another step, the aluminum workpiece is assembled into a workpiece stack-up along with a steel workpiece such that the workpiece stack-up includes the aluminum workpiece and the steel workpiece arranged in overlapping fashion with the metallurgical additive deposit being located between the faying surface of the aluminum workpiece and a faying surface of the steel workpiece. In yet another step, a weld face of a first welding electrode is pressed against an aluminum workpiece surface that provides a first side of the workpiece stack-up, and a weld face of a second welding electrode is pressed against a steel workpiece surface that provides a second side of the workpiece stack-up. In still another step, an electrical current is passed through the workpiece stack-up and between the weld faces of the first and second welding electrodes to create a molten aluminum weld pool within the workpiece stack-up. The molten aluminum weld pool wets the faying surface of the steel workpiece and having the metallurgical additive deposit suspended therein to counteract growth and formation of Fe—Al intermetallic compounds against the faying surface of the steel workpiece. In another step, the passage of the electrical current is terminated to allow the molten aluminum weld pool to solidify into a weld joint that weld bonds the aluminum and steel workpieces together.

The aforementioned embodiment of the disclosed method may include additional steps and/or be further defined. For example, the metallurgical additive deposit may be a ferrous alloy that includes at least one of 0.050 wt % carbon to 1.0 wt % carbon, 0.1 wt % to 10 wt % silicon, 0.5 wt % to 20 wt % nickel, 0.5 wt % to 30 wt % manganese, 0.5 wt % to 20 wt % chromium, or 0.5 wt % to 50 wt % cobalt. In another example, the metallurgical additive deposit may be unalloyed nickel, unalloyed copper, or an alloy rich in nickel or copper. Still further, the metallurgical additive deposit may be deposited onto the faying surface of the aluminum workpiece by oscillation wire arc welding.

A method of resistance spot welding a workpiece stack-up that that includes an aluminum workpiece and an adjacent overlapping steel workpiece according to another embodiment of the present disclosure may include several steps. In one step, a metallurgical additive deposit is deposited onto a faying surface of a steel workpiece such that the metallurgical additive deposit is adhered to the faying surface of the steel workpiece. The metallurgical additive deposit is a metal that comprises at least one of carbon, silicon, nickel, manganese, chromium, cobalt, or copper. In another step, the steel workpiece is assembled into a workpiece stack-up along with an aluminum workpiece such that the workpiece stack-up includes the steel workpiece and the aluminum workpiece arranged in overlapping fashion with the metallurgical additive deposit being located between the faying surface of the steel workpiece and a faying surface of the aluminum workpiece. In still another step, a weld face of a first welding electrode is pressed against an aluminum workpiece surface that provides a first side of the workpiece stack-up, and a weld face of a second welding electrode is pressed against a steel workpiece surface that provides a second side of the workpiece stack-up. In yet another step, an electrical current is passed through the workpiece stack-up and between the weld faces of the first and second welding electrodes to create a molten aluminum weld pool within the workpiece stack-up. The molten aluminum weld pool wets a surface of the metallurgical additive deposit and, if available, the faying surface of the steel workpiece to counteract growth and formation of Fe—Al intermetallic compounds against the faying surface of the steel workpiece. In another step, the passage of the electrical current is terminated to allow the molten aluminum weld pool to solidify into a weld joint that weld bonds the aluminum and steel workpieces together.

The aforementioned embodiment of the disclosed method may include additional steps and/or be further defined. For example, the metallurgical additive deposit may be a ferrous alloy that includes at least one of 0.050 wt % carbon to 1.0 wt % carbon, 0.1 wt % to 10 wt % silicon, 0.5 wt % to 20 wt % nickel, 0.5 wt % to 30 wt % manganese, 0.5 wt % to 20 wt % chromium, or 0.5 wt % to 50 wt % cobalt. In another example, the metallurgical additive deposit may be unalloyed nickel, unalloyed copper, or an alloy rich in nickel or copper. Still further, the metallurgical additive deposit may be deposited onto the faying surface of the aluminum workpiece by oscillation wire arc welding.

### BRIEF DESCRIPTION OF THE DRAWINGS

FIG. 1 is a cross-sectional illustration of one embodiment of a workpiece stack-up that includes overlapping aluminum and steel workpieces along with an intermediate metallurgical additive disposed between the faying surfaces of the aluminum and steel workpieces at a welding zone of the stack-up;

FIG. 2 is a cross-sectional illustration of another embodiment of a workpiece stack-up that includes overlapping aluminum and steel workpieces along with an intermediate metallurgical additive disposed between the faying surfaces of the aluminum and steel workpieces at a welding zone of the stack-up, although here the workpiece stack-up includes an additional aluminum workpiece;

FIG. 3 is a cross-sectional illustration of yet another embodiment of a workpiece stack-up that includes overlapping aluminum and steel workpieces along with an intermediate metallurgical additive disposed between the faying surfaces of the aluminum and steel workpieces at a welding zone of the stack-up, although here the workpiece stack-up includes an additional steel workpiece;

FIG. 4 is a cross-sectional illustration of an additive electrode rod that, during oscillating wire arc welding, has been brought into initial contact with a faying surface of the aluminum or steel workpiece;

FIG. 5 is a cross-sectional illustration of an additive electrode rod that, during oscillating wire arc welding, has been retracted from the faying surface of the aluminum or steel workpiece, after making initial contact with that surface, to strike an arc;

FIG. 6 is a cross-sectional illustration of a molten metallurgical additive droplet that, during oscillating wire arc welding, has formed at the tip of the additive electrode rod due to the heat generated by the arc;

FIG. 7 is a cross-sectional illustration of the molten metallurgical additive droplet in FIG. 6 being brought into contact with the faying surface of the aluminum or steel workpiece during oscillating wire arc welding;

FIG. 8 is a cross-sectional illustration of a metallurgical additive deposit after the additive electrode rod has left behind a molten metallurgical additive droplet that later solidified; and

FIG. 9 is a general cross-sectional view of a workpiece stack-up, which includes an aluminum workpiece and an adjacent steel workpiece assembled in overlapping fashion with the intermediate metallurgical additive, situated between a set of opposed welding electrodes in preparation for resistance spot welding;

FIG. 10 is a general cross-sectional view of the workpiece stack-up and welding electrodes shown in FIG. 9 during passage of electrical current between the welding electrodes and through the stack-up, wherein the passage of electrical current has caused melting of the aluminum workpiece that lies adjacent to the steel workpiece and the creation of a molten aluminum weld pool within the aluminum workpiece; and

FIG. 11 is a general cross-sectional view of the workpiece stack-up and welding electrodes shown in FIG. 9 after passage of the electrical current between the welding electrodes and through the stack-up has terminated so as to allow the molten aluminum weld pool to solidify into a weld joint that bonds the adjacent aluminum and steel workpieces together.

### DETAILED DESCRIPTION

A method of resistance spot welding an aluminum workpiece and a steel workpiece with the assistance of an intermediate metallurgical additive placed between the workpieces is disclosed. The intermediate metallurgical additive is adhered to a faying surface of the aluminum workpiece or a faying surface of the steel workpiece, and is positioned between the faying surfaces of the two workpieces within a welding zone when the workpieces are subsequently assembled in a lapped configuration into a workpiece stack-up. The intermediate metallurgical additive is exposed to the molten aluminum alloy weld pool during spot welding and is designed counteracts the growth of a Fe—Al intermetallic layer at the bonding interface of the resultant weld joint and a surface of the intermediate metallurgical additive, the steel workpiece, or both. For instance, the intermediate metallurgical additive may be a metal that contains carbon, silicon, nickel, manganese, chromium, cobalt, and/or copper. Alloys that include C, Si, Ni, Mn, Cr, and/or Co, and, in particular, ferrous alloys of those elements, can inhibit the growth of a Fe—Al intermetallic layer, while pure Ni and pure Cu, or alloys rich in Ni or Cu, can promote the formation of a more favorable Ni—Al and/or Cu—Al intermetallic layer in lieu of a Fe—Al intermetallic layer.

The intermediate metallurgical additive is preferably adhered to the faying surface of the aluminum workpiece or the faying surface of the steel workpiece by way of oscillating wire arc welding, although other techniques may certainly be used as well. Oscillating wire arc welding is preferred here since that process can apply the metallurgical additive in a molten state onto the faying surface of the steel and/or aluminum workpiece from a consumable electrode rod. In this way, a specified amount of the molten metallurgical additive can be consistently applied in a particular location to produce, upon solidification, a metallurgical additive deposit that is adhered (brazed or fusion welded) to its adjoining faying surface and whose size and shape can be precisely controlled. Moreover, because the metallurgical additive deposit is adhered in place, the oscillating wire arc welding process does not have to be practiced just prior to the commencement of spot welding. In fact, if desired, the metallurgical additive deposit can be put in place long before the corresponding aluminum/steel workpiece is needed for spot welding. Such process flexibility even permits the deposition of the metallurgical additive deposit to be carried out on dedicated equipment independent from the spot welding equipment.

The practice of the disclosed method limits the growth of a Fe—Al intermetallic layer, which is typically comprises FeAl₃ and Fe₂Al₅ compounds, at the bonding interface of the weld joint and the faying surface of the steel workpiece. The ability to minimize or altogether eliminate the formation of the Fe—Al intermetallic layer at the weld joint bonding interface is noteworthy since Fe—Al intermetallic compounds and their resultant layers are harder, more brittle, and less tough than the rest of the weld joint. Excessive growth of a Fe—Al intermetallic layer can thus make the weld joint more susceptible to rapid crack growth that may originate from the notch root of the joint. A high susceptibility to rapid crack grow can, in turn, weaken the peel and cross-tension strength of the weld joint and ultimately lead to interfacial joint fracture when the weld joint is subjected to loading. The disclosed method offers a solution to the challenges associated with the Fe—Al intermetallic layer that is not overly complex to implement, particularly in a manufacturing setting, and does not necessitate significant modifications to existing spot welding equipment.

FIGS. 1-11 illustrate an exemplary embodiment of the disclosed method in which a workpiece stack-up 10 that includes an aluminum workpiece 12 and an adjacent overlapping steel workpiece 14 is resistance spot welded to join together the two workpieces 12, 14 with the assistance of an intermediate metallurgical additive 16. With reference specifically to FIGS. 1-3, the workpiece stack-up 10 has a first side 18 and a second side 20 and includes at least the adjacent pair of aluminum and steel workpieces 12, 14 which, as shown, overlap and confront one another to establish a faying interface 22 that encompasses a welding zone 24. The first side 18 of the workpiece stack-up 10 is provided by an aluminum workpiece surface 26 and the second side 20 of the stack-up 10 is provided by a steel workpiece surface 28. The workpiece stack-up 10 may thus be a “2T” stack-up that includes only (in terms of the number of workpieces) the adjacent pair of aluminum and steel workpieces 12, 14, a “3T” stack-up that includes the adjacent pair of aluminum and steel workpieces 12, 14 plus an additional aluminum workpiece or an additional steel workpiece so long as the two workpieces of the same base metal composition are disposed next to each other (i.e., aluminum-aluminum-steel or aluminum-steel-steel), or it may include more than three workpieces such as an aluminum-aluminum-steel-steel stack-up, an aluminum-aluminum-aluminum-steel stack-up, or an aluminum-steel-steel-steel stack-up.

The aluminum workpiece 12 includes an aluminum substrate that is either coated or uncoated. The aluminum substrate may be composed of unalloyed aluminum or an aluminum alloy that includes at least 85 wt % aluminum. Some notable aluminum alloys that may constitute the coated or uncoated aluminum substrate are an aluminum-magnesium alloy, an aluminum-silicon alloy, an aluminum-magnesium-silicon alloy, and an aluminum-zinc alloy. If coated, the aluminum substrate may include a surface layer of a refractory oxide material comprised of aluminum oxide compounds and possibly other oxide compounds as well, such as magnesium oxide compounds if, for example, the aluminum substrate is an aluminum-magnesium alloy. Such a refractory oxide material may be a native oxide coating that forms naturally when the aluminum substrate is exposed to air and/or an oxide layer created during exposure of the aluminum substrate to elevated temperatures during manufacture, e.g., a mill scale. The aluminum substrate may also be coated with a layer of zinc, tin, or a metal oxide conversion coating comprised of oxides of titanium, zirconium, chromium, or silicon, as described in US2014/0360986. The surface layer may have a thickness ranging from 1 nm to 10 μm and may be present on each side of the aluminum substrate. Taking into account the thickness of the aluminum substrate and any surface coating that may be present, the aluminum workpiece 12 has a thickness 120 that ranges from 0.3 mm to about 6.0 mm, or more narrowly from 0.5 mm to 3.0 mm, at least at the welding zone 24.

The aluminum substrate of the aluminum workpiece 12 may be provided in wrought or cast form. For example, the aluminum substrate may be composed of a 4xxx, 5xxx, 6xxx, or 7xxx series wrought aluminum alloy sheet layer, extrusion, forging, or other worked article. Alternatively, the aluminum substrate may be composed of a 4xx.x, 5xx.x, 6xx.x, or 7xx.x series aluminum alloy casting. Some more specific kinds of aluminum alloys that may constitute the aluminum substrate include, but are not limited to, AA5754 and AA5182 aluminum-magnesium alloy, AA6111 and AA6022 aluminum-magnesium-silicon alloy, AA7003 and AA7055 aluminum-zinc alloy, and Al-10Si—Mg aluminum die casting alloy. The aluminum substrate may further be employed in a variety of tempers including annealed (O), strain hardened (H), and solution heat treated (T), if desired. The term “aluminum workpiece” as used herein thus encompasses unalloyed aluminum and a wide variety of aluminum alloys, whether coated or uncoated, in different spot-weldable forms including wrought sheet layers, extrusions, forgings, etc., as well as castings.

The steel workpiece 14 includes a steel substrate from any of a wide variety of grades and strengths that is either coated or uncoated. The steel substrate may be hot-rolled or cold-rolled and may be composed of steel such as mild steel, interstitial-free steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel such as when the steel workpiece 14 includes press-hardened steel (PHS). Preferred compositions of the steel substrate, however, include mild steel, dual phase steel, and boron steel used in the manufacture of press-hardened steel. Those three types of steel have ultimate tensile strengths that, respectively, range from 150 MPa to 500 MPa, from 500 MPa to 1100 MPa, and from 1200 MPa to 1800 MPa.

The steel substrate, if coated, preferably includes a surface layer of zinc (galvanized), a zinc-iron alloy (galvanneal), an electrodeposited zinc-iron alloy, a zinc-nickel alloy, nickel, aluminum, an aluminum-magnesium alloy, an aluminum-zinc alloy, or an aluminum-silicon alloy, any of which may have a thickness of up to 50 μm and may be present on each side of the steel substrate. Taking into account the thickness of the steel substrate and any coating that may be present, the steel workpiece 14 has a thickness 140 that ranges from 0.3 mm and 6.0 mm, or more narrowly from 0.6 mm to 2.5 mm, at least at the welding zone 24. The term “steel workpiece” as used herein thus encompasses a wide variety of spot-weldable steels, whether coated or uncoated, of different strengths and grades.

When the aluminum and steel workpieces 12, 14 are stacked-up for spot welding in the context of a “2T” stack-up embodiment, which is illustrated in FIG. 1, the aluminum workpiece 12 and the steel workpiece 14 present the first and second sides 18, 20 of the workpiece stack-up 10, respectively. In particular, the aluminum workpiece 12 includes a faying surface 30 and an exposed back surface 32 and, likewise, the steel workpiece 14 includes a faying surface 34 and an exposed back surface 36. The faying surfaces 30, 34 of the two workpieces 12, 14 overlap and confront one another to establish the faying interface 22 that extends through the welding zone 24. The exposed back surfaces 32, 36 of the aluminum and steel workpieces 12, 14, on the other hand, face away from one another in opposite directions at the welding zone 24 and constitute, respectively, the aluminum workpiece surface 26 and the steel workpiece surface 28 that provide the first and second sides 18, 20 of the workpiece stack-up 10.

The term “faying interface 22” is used broadly in the present disclosure and is intended to encompass any overlapping and confronting relationship between the faying surfaces 30, 34 of the aluminum and steel workpieces 12, 14 in which resistance spot welding can be practiced. Each of the faying surfaces 30, 34 may, for example, be in direct contact with the intermediate metallurgical additive 16 within the welding zone 24 while the portions of the faying surfaces 30, 34 outside of the intermediate metallurgical additive 16 are in direct contact with one another or separated by a gap. As another example, the faying surface 30 of the aluminum workpiece 12 or the faying surface 34 of the steel workpiece 14 may be in indirect contact with the other faying surface 30, 34 and/or the intermediate metallurgical additive 16 such as when the aluminum and steel workpieces 12, 14 are separated by an intervening organic material layer (e.g., an adhesive or a sealer). This type of indirect contact between the faying surfaces 30, 34 and/or between one or both of the faying surfaces 30, 34 and the intermediate metallurgical additive 16 can result, for example, when an adhesive layer (not shown) is broadly applied between the faying surfaces 30, 34. Any such organic material layer will be laterally displaced from the welding zone 24 and any residual from that layer will be thermally decomposed during the spot welding process so as not to interfere with the formation of the weld joint that ultimately bonds the aluminum and steel workpieces 12, 14 together.

An adhesive layer that may be present between the faying surfaces 30, 34 of the aluminum and steel workpieces 12, 14 is one that preferably includes a structural thermosetting adhesive matrix. The structural thermosetting adhesive matrix may be any curable structural adhesive including, for example, as a heat-curable epoxy or a heat curable polyurethane. Some specific examples of heat-curable structural adhesives that may be used as the adhesive matrix include DOW Betamate 1486, Henkel Terokal 5089, and Uniseal 2343, all of which are commercially available. Additionally, the adhesive layer may further include optional filler particles, such as fumed silica particles, dispersed throughout the thermosetting adhesive matrix to modify the viscosity profile or other properties of the adhesive layer for manufacturing operations. The adhesive layer, if present, preferably has a thickness of 0.1 mm to 2.0 mm and is typically intended to provide additional bonding between the workpieces 12, 14 outside of the welding zone 24 upon being cured in an ELPO-bake oven or other heating apparatus following resistance spot welding of the workpiece stack-up 10.

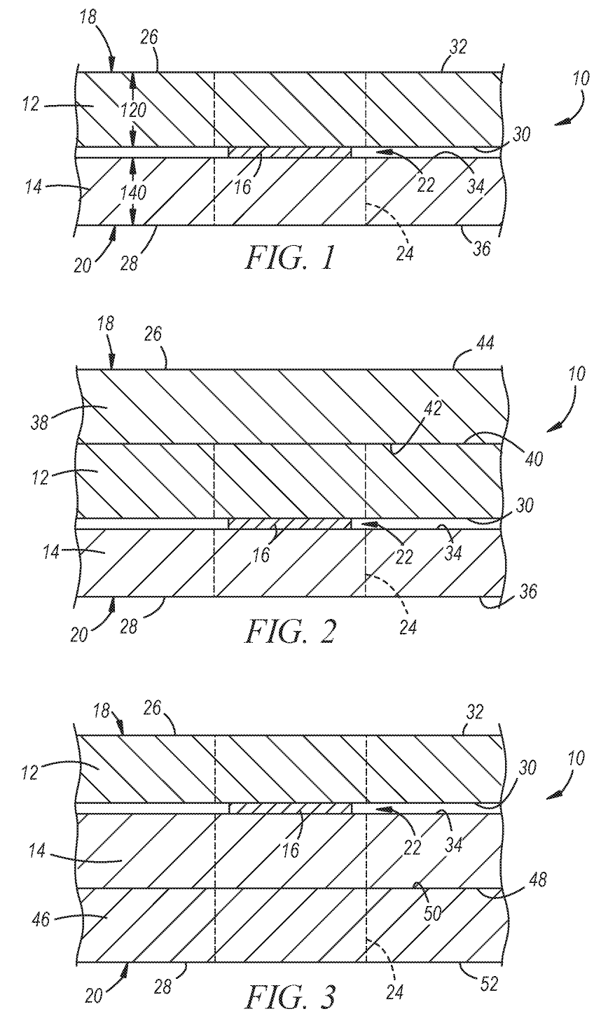

Of course, as shown in FIGS. 2-3, the workpiece stack-up 10 is not limited to the inclusion of only the aluminum workpiece 12 and the adjacent steel workpiece 14. The workpiece stack-up 10 may also include at least an additional aluminum workpiece or at least an additional steel workpiece—in addition to the adjacent pair of aluminum and steel workpieces 12, 14—so long as the additional workpiece(s) are disposed adjacent to the workpiece 12, 14 of the same base metal composition; that is, any additional aluminum workpiece(s) are disposed adjacent to the aluminum workpiece 12 and any additional steel workpiece(s) are disposed adjacent to the steel workpiece 14. As for the characteristics of the additional workpiece(s), the descriptions of the aluminum workpiece 12 and the steel workpiece 14 provided above are applicable to any additional aluminum or steel workpiece that may be included in the workpiece stack-up 10. It should be noted, though, that while the same general descriptions apply, there is no requirement that the multiple aluminum workpieces or the multiple steel workpieces of the workpiece stack-up 10 be identical in terms of composition, thickness, or form (e.g., wrought or cast).

As shown in FIG. 2, for example, the workpiece stack-up 10 may include the adjacent pair of aluminum and steel workpieces 12, 14 described above along with an additional aluminum workpiece 38. Here, as shown, the additional aluminum workpiece 38 overlaps the pair of aluminum and steel workpieces 12, 14 and lies adjacent to the aluminum workpiece 12. When the additional aluminum workpiece 38 is so positioned, the exposed back surface 36 of the steel workpiece 14 constitutes the steel workpiece surface 28 that provides the second side 20 of the workpiece stack-up 10, as before, while the aluminum workpiece 12 that lies adjacent to the steel workpiece 14 now includes a pair of opposed faying surfaces 30, 40. The faying surface 30 of the aluminum workpiece 12 that faces the steel workpiece 14 continues to establish the faying interface 22 along with the confronting faying surface 34 of the steel workpiece 14 and the intermediate metallurgical additive 16 as previously described. The other faying surface 40 of the aluminum workpiece 12 overlaps and confronts a faying surface 42 of the additional aluminum workpiece 38. As such, in this particular arrangement of lapped workpieces 38, 12, 14, an exposed back surface 44 of the additional aluminum workpiece 38 now constitutes the aluminum workpiece surface 26 that provides the first side 18 of the workpiece stack-up 10.

In another example, as shown in FIG. 3, the workpiece stack-up 10 may include the adjacent pair aluminum and steel workpieces 12, 14 described above along with an additional steel workpiece 46. Here, as shown, the additional steel workpiece 46 overlaps the pair of aluminum and steel workpieces 12, 14 and lies adjacent to the steel workpiece 14. When the additional steel workpiece 46 is so positioned, the exposed back surface 32 of the aluminum workpiece 12 constitutes the aluminum workpiece surface 26 that provides the first side 18 of the workpiece stack-up 10, as before, while the steel workpiece 14 that lies adjacent to the aluminum workpiece 12 now includes a pair of opposed faying surfaces 34, 48. The faying surface 34 of the steel workpiece 14 that faces the aluminum workpiece 12 continues to establish the faying interface 22 along with the confronting faying surface 30 of the aluminum workpiece 12 and the intermediate metallurgical additive 16 as previously described. The other faying surface 48 of the steel workpiece 14 overlaps and confronts a faying surface 50 of the additional steel workpiece 46. As such, in this particular arrangement of lapped workpieces 12, 14, 46, an exposed back surface 52 of the additional steel workpiece 46 now constitutes the steel workpiece surface 28 that provides the second side 20 of the workpiece stack-up 10.

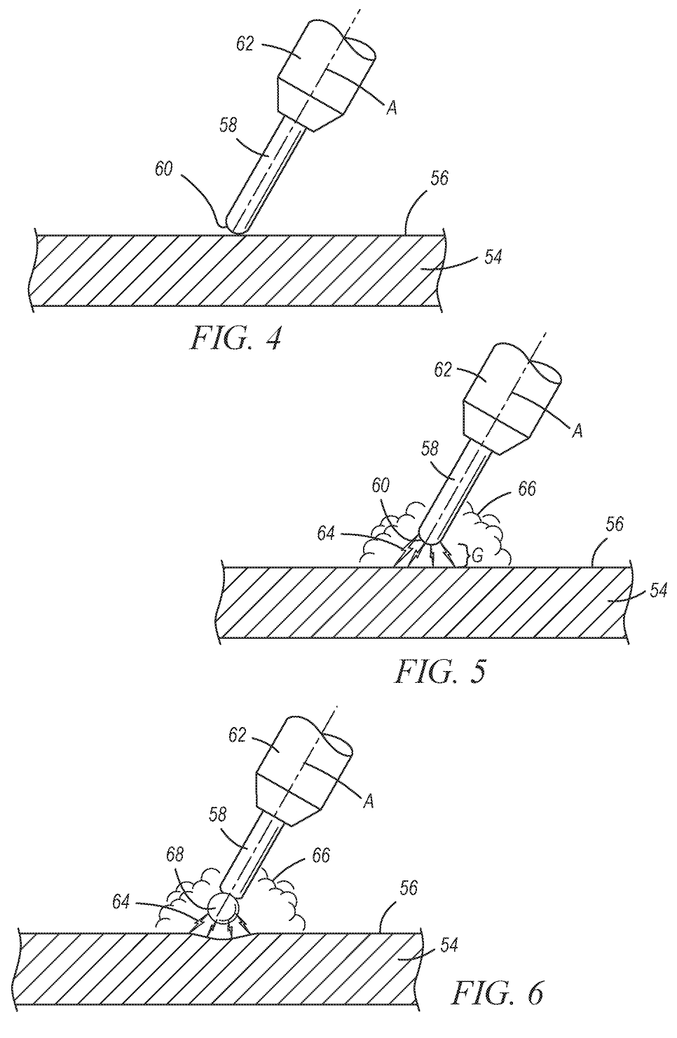

Turning now to FIGS. 4-11, the various stages of the disclosed method in which the pair of adjacent aluminum and steel workpieces 12, 14 is ultimately spot welded together at the welding zone 24 are illustrated. First, a metallurgical additive composition is deposited onto the faying surface 30 of the aluminum workpiece 30 or the faying surface 34 of the steel workpiece 14 using an oscillating wire arc welding process, which results in a metallurgical additive deposit 70 (FIG. 8) being metallurgically adhered to its adjoining faying surface. Second, the aluminum and steel workpieces 12, 14 are assembled into the workpiece stack-up 10 (examples of which are shown in FIGS. 1-3) to establish the faying interface 22 with the resultant intermediate metallurgical additive 16 being situated between the opposed faying surfaces 30, 34 of the aluminum and steel workpieces 12, 14. And third, the aluminum and steel workpieces 12, 14 are weld bonded together at the welding zone 24 through the practice of resistance spot welding. It should be noted that while the workpiece stack-up 10 shown in FIGS. 9-11 depicts only the adjacent pair of aluminum and steel workpieces 12, 14, the accompanying description applies equally to circumstances in which the stack-up 10 includes one or more additional aluminum and/or steel workpieces.

The pre-placement of the metallurgical additive deposit 70 onto the aluminum workpiece 12 or the steel workpiece 14 is illustrated in FIGS. 4-8. In those Figures, reference is made to a workpiece 54 having a faying surface 56, which, for the sake of brevity and clarity, is intended to be representative of each of the aluminum and steel workpieces and their respective faying surfaces 30, 34. With that being said, to carry out this stage of the disclosed method, the metallurgical additive composition that constitutes the metallurgical additive deposit 70 is initially packaged in the form of a consumable electrode rod 58 that has a leading tip end 60. The consumable electrode rod 58 protrudes from a guide nozzle 62 and is reciprocally moveable along its longitudinal axis A. The consumable electrode rod 58 is also connected to a welding power supply (not shown) by an electrode cable. Likewise, to complete the arc welding circuit, the workpiece 54 is connected to the welding power supply by a work cable. The welding power supply may be constructed to deliver a direct current (DC) or an alternating current (AC) of sufficient strength through the consumable electrode rod 58, which may be assigned either a negative polarity or a positive polarity, so that an arc can be struck between the consumable electrode rod 58 and the faying surface 56 of the workpiece 54 as will be further described below.

The metallurgical additive composition incorporated into the consumable electrode rod 58 may be a metal that contains carbon silicon, nickel, manganese, chromium, cobalt, and/or copper. Alloys that include C, Si, Ni, Mn, Cr, and/or Co are suitable candidates for the metallurgical additive composition since those elements act as Fe—Al intermetallic compound inhibitors when exposed to the molten aluminum weld pool created within the aluminum workpiece during resistance spot welding. Several examples of preferred alloys that may be used include ferrous-based alloys that include at least one of 0.050 wt % to 1.0 wt % carbon, 0.1 wt % to 10 wt % silicon, 0.5 wt % to 20 wt % nickel, 0.5 wt % to 30 wt % manganese, 0.5 wt % to 20 wt % chromium, or 0.5 wt % to 50 wt % cobalt. Pure unalloyed nickel, pure unalloyed copper, and an alloy rich (>50 wt %) in nickel or copper, on the other hand, are suitable candidates for the metallurgical additive composition for a somewhat different reason; that is, the exposure of nickel and/or copper to the molten aluminum weld pool promotes the formation of Ni—Al and/or Cu—Al intermetallic compounds—and thus suppresses the formation of the less favorable Fe—Al intermetallic compounds—at the bonding interface of the weld joint.

Referring still to FIG. 4, the early phase of oscillating wire arc welding includes protracting the consumable electrode rod 58 along its longitudinal axis A to bring the tip end 60 into contact with the faying surface 56 of the workpiece 54. The longitudinal axis A of the consumable electrode rod 58 may be oriented normal to the faying surface 56 or, as shown, it may be inclined at an angle to facilitate access to the faying surface 56. Once the tip end 60 of the consumable electrode rod 58 makes contact with the faying surface 56, the welding power supply is turned on and an electrical current is applied and passed through the consumable electrode rod 58. The amount of current passed through the rod 58 depends on the metallurgical additive composition and the diameter of the rod 58. For example, when the consumable electrode rod 58 has a diameter of 1.0 mm, the current passed through the rod 58 typically ranges from 20 A to 250 A for the wide variety of the possible metallurgical additive compositions listed above.

After contact is established between the tip end 60 and the faying surface 56 and current is flowing, the consumable electrode rod 58 is retracted from the faying surface 56 of the workpiece 54 along its longitudinal axis A, as shown in FIG. 5, typically to a pre-set distance away from the faying surface 56. The retraction of the consumable electrode rod 58 results in the tip end 60 of the rod 58 being displaced from the faying surface 56 by a gap G that is initially equal to the pre-set retraction distance. The ensuing electrical potential difference between the separated parts causes an arc 64 to be struck across the gap G and between the tip end 60 of the rod 58 and the faying surface 56 of the workpiece 54. The arc 64 heats the tip end 60 and initiates melting of the consumable electrode rod 58 at that location. A shielding gas—usually comprised of argon, helium, carbon dioxide, or mixtures thereof—may be directed at the workpiece 54 to provide for a stable arc 64 and to establish a protective zone 66 that prevents atmospheric oxygen from contaminating the molten portion of the consumable electrode rod 58.

The melting of the consumable electrode rod 58 by the arc 64 causes a molten metallurgical additive droplet 68 to collect at the tip end 60 of the electrode rod 58, as depicted in FIG. 6. This droplet 68, which is retained by surface tension, grows in volume and becomes further displaced from the faying surface 56 of the workpiece 54 after the rod 58 has been retracted to its pre-set distance as a result of the consumable electrode rod 58 being consumed and the leading tip end 60 receding up the longitudinal axis A of the rod 58. The size of the gap G thus increases as the arc 64 melts and consumes the consumable electrode rod 58 so as to grow the molten metallurgical additive droplet 68. Indeed, during the time the molten metallurgical additive droplet 68 is being grown, the consumable electrode rod 58 may be held stationary or it may be protracted towards the faying surface 56 at a slower rate than the rate at which the electrode rod 58 is being consumed up its longitudinal axis A in order to afford some control over the growth rate of the molten metallurgical additive droplet 68 and the rate at which the gap G is increasing.

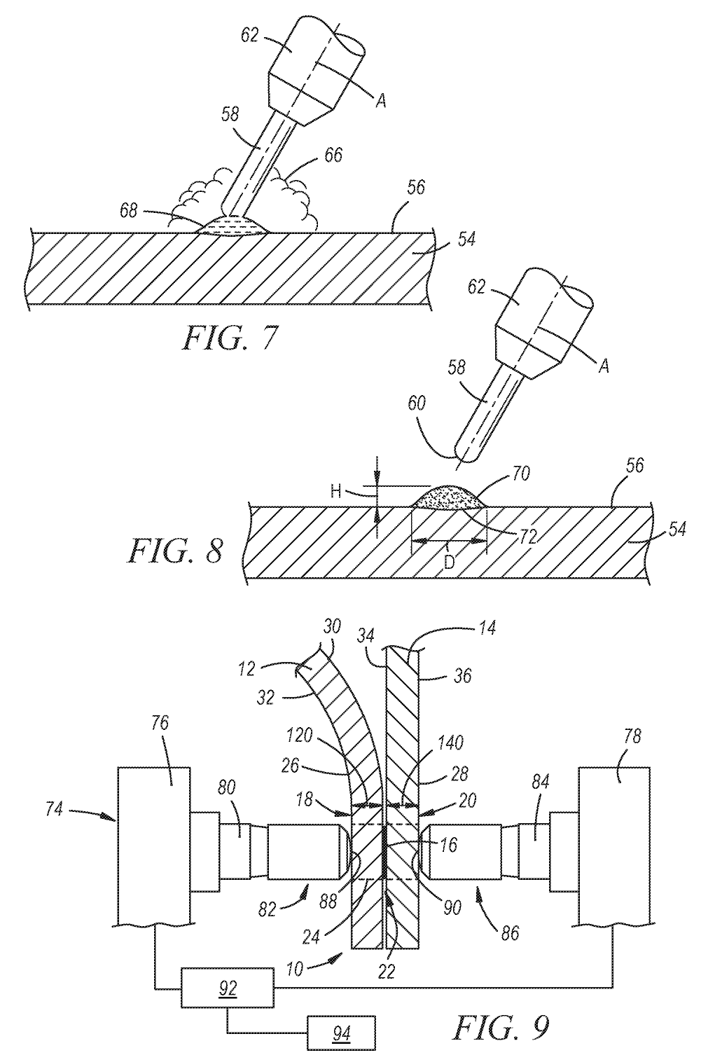

Once the molten metallurgical additive droplet 68 has formed and attained a desired volume, the consumable electrode rod 58 is protracted along its longitudinal axis A to bring the molten metallurgical additive droplet 68 into contact with the faying surface 56 of the workpiece 54, as shown in FIG. 7. The convergence of the molten metallurgical additive droplet 68 and the faying surface 56 of the workpiece 54 as a result of the forward protracting movement of the rod 58 extinguishes the arc 64, at which point the current applied from the welding power supply may be increased by 125% to 150%. The contacting molten metallurgical additive droplet 68 wets or coalesces with the faying surface 56 of the workpiece 54 depending on the melting point of the metallurgical additive composition and the composition (aluminum or steel) of the workpiece 54. After the molten metallurgical additive droplet 68 has been brought into contact with the faying surface 56 of the workpiece 54, and the applied current increased, the consumable electrode rod 58 is once again retracted along its longitudinal axis A, as shown in FIG. 8 (showing the metallurgical additive deposit 70 after the molten reaction material droplet 64 has solidified).

The retraction of the consumable electrode rod 58 away from the faying surface 56 transfers the molten metallurgical additive droplet 68 to the faying surface 56 of the workpiece 54. Such detachment and transfer of the molten metallurgical additive droplet 68 is believed to be aided in part by the increase in the applied current after the droplet 68 is brought into contact with the faying surface 56. That is, the 125% to 150% increase in the applied current helps detach the molten metallurgical additive droplet 68 by ensuring that any surface tension that may be acting to hold the droplet 68 onto the consumable electrode rod 58 is overcome. The molten metallurgical additive droplet 68 that is transferred to the faying surface 56 eventually solidifies into all or part of the metallurgical additive deposit 70 as shown in FIG. 8. The metallurgical additive deposit 70 is adhered to the faying surface 56 of the workpiece 54 by a joint 72, which may be in the form of a braze joint or a fusion weld joint, and can assume a wide variety of sizes and shapes. For instance, the metallurgical additive deposit 70 may have a hemispherical or rectangular cross-sectional profile, as well as others, and it may have a height H of 0.1 mm to 1.0 mm and a base diameter D that ranges from 0.5 mm to 15 mm or, more narrowly, from 2 mm to 8 mm. Moreover, depending on the size and shape of the metallurgical additive deposit 70, and the specifics of the workpiece stack-up 10, multiple deposits 70 may be pre-placed despite the fact that only a single representative deposit 70 is shown in the Figures.

The metallurgical additive deposit 70 may be produced through a single cycle of the oscillating wire arc welding process, as just described, or it may be desirable to carry out one or more additional oscillating wire arc welding cycles to modify the volume, shape, and/or internal consistency of the deposit 70. In one embodiment, for example, after the consumable electrode rod 58 is retracted from the faying surface 56 and the molten metallurgical additive droplet 68 is transferred, thus completing the first oscillating wire arc welding cycle, a second oscillating wire arc welding cycle may be performed. In so doing, the applied current provided by the welding power supply may be returned to its initial level and an arc 64 may once again be struck across the gap G between the tip end 60 of the consumable electrode rod 58 and the faying surface 56 (which now includes the previously applied molten metallurgical additive droplet). The consumable electrode rod 58 is then protracted along its axis A to join another molten metallurgical additive droplet 68 with the metallurgical additive previously deposited on the faying surface 56 of the workpiece 54 during the first oscillating wire arc welding cycle. The consumable electrode rod 58 may then be retracted along its longitudinal axis A with an increased applied current level to facilitate transfer of the second molten metallurgical additive droplet 68, which completes the second oscillating wire arc welding cycle. Multiple additional cycles may be carried out in the same way. Additionally, multiple discrete metallurgical additive deposits 70 may be deposited onto the faying surface 56 using the same oscillating wire arc welding process described above.

After the metallurgical additive deposit 70 is adhered in place to the faying surface 56 (which may be the faying surface 30 of the aluminum workpiece 12 or the faying surface 34 of the steel workpiece 12), the workpiece stack-up 10 is assembled in preparation for resistance spot welding. In particular, the aluminum and steel workpieces 12, 14 are arranged in a lapped configuration such that the metallurgical additive deposit(s) 70 are disposed between the faying surfaces 30, 34 at the welding zone 24 to provide the intermediate metallurgical additive 16, as shown in the embodiments illustrated in FIGS. 1-3. The workpiece stack-up 10 may also optionally include at least an additional aluminum workpiece or at least an additional steel workpiece as described above. Once assembled, and as shown in FIG. 9, the workpiece stack-up 10 is brought to a weld gun 74 (partially shown) of any suitable type including, for example, a C-type or an X-type weld gun. The weld gun 74 is part of a larger automated welding operation and may be configured as a stationary pedestal weld gun or it may be mounted on robotic system to facilitate coordinated movement around the workpiece stack-up 10.

The weld gun 74 includes a first gun arm 76 and a second gun arm 78. The first gun arm 76 is fitted with a shank 80 that secures and retains a first welding electrode 82 and the second gun arm 78 is fitted with a shank 84 that secures and retains a second welding electrode 86. The secured retention of the welding electrodes 82, 86 on their respective shanks 80, 84 can be accomplished by way of shank adapters that are located at axial free ends of the shanks 80, 84 and received by the electrodes 82, 86. In terms of their positioning relative to the workpiece stack-up 10, the first welding electrode 82 is positioned for contact with the aluminum workpiece surface 26 that provides the first side 18 of the stack-up 10, and, consequently, the second welding electrode 86 is positioned for contact with the steel workpiece surface 28 that provides the second side 80 of the stack-up 10. The first and second weld gun arms 76, 78 are operable to converge or pinch the welding electrodes 82, 86 towards each other so that they press against their respective sides 18, 20 of the of the stack-up 10 to impose a clamping force on the stack-up 10 at the welding zone 24.

The first and second welding electrodes 82, 86 are each formed from an electrically conductive material such as, for example, a copper alloy. One specific example is a copper-zirconium alloy (CuZr) that contains 0.10 wt % to 0.20 wt % zirconium and the balance copper. Copper alloys that meet this constituent composition and are designated C15000 are well known. Other copper alloys may of course be employed including a copper-chromium alloy (CuCr) or a copper-chromium-zirconium alloy (CuCrZr). A specific example of each of the aforementioned copper alloys is a C18200 copper chromium alloy that includes 0.6 wt % to 1.2 wt % chromium and the balance copper and a C18150 copper-chromium-zirconium alloy includes 0.5 wt % to 1.5 wt % chromium, 0.02 wt % to 0.20 wt % zirconium, and the balance copper. Still further, other compositions that possess suitable mechanical and electrical/thermal conductivity properties may also be used including a dispersion strengthened copper material such as copper with an aluminum oxide dispersion or a more resistive refractory metal (e.g., molybdenum or tungsten) or a refractory metal composite (e.g. tungsten-copper).

The first welding electrode 82 includes a first weld face 88 and the second welding electrode 86 includes a second weld face 90. The weld faces 88, 90 of the first and second welding electrodes 82, 86 are the portions of the electrodes 82, 86 that are pressed against, and impressed into, the opposite sides 18, 20 of the workpiece stack-up 10 during each instance the weld gun 74 is operated to conduct spot welding. A broad range of electrode weld face designs may be implemented for each of the welding electrodes 82, 86. Each of the weld faces 88, 90 may be flat or domed, and may further include oxide-disrupting surface features (e.g., a microtextured surface roughness, a series of upstanding circular ridges or recessed circular grooves, a plateau, etc.) as described, for example, in U.S. Pat. Nos. 6,861,609, 8,222,560, 8,274,010, 8,436,269, 8,525,066, and 8,927,894, and U.S. Pat. Pub. No. 2013/0015164, each of which is incorporated herein by reference in its entirety. A mechanism for cooling the electrodes 82, 86 with water is also typically incorporated into the gun arms 76, 78 and the welding electrodes 82, 86 to manage the temperatures of the electrodes 82, 86.

The first and second welding electrodes 82, 86 can share the same general configuration or a different one. In a preferred embodiment, for example, the first weld face 88 has a diameter between 6 mm and 22 mm, or more narrowly between 8 mm and 15 mm, and has a convex domed shape that may be in the form of a portion of a sphere having a radius of curvature between 15 mm and 300 mm, or more narrowly between 20 mm and 50 mm. The second weld face 90, on the other hand, preferably has a diameter between 3 mm and 16 mm, or more narrowly between 4 mm and 8 mm, and has a convex dome shape that may be in the form of a portion of s sphere having a radius of curvature between 25 mm and 400 mm, or more narrowly between 25 mm and 100 mm. Each weld face 82, 86 may further include a series of upstanding circular ridges that project outwardly from a base surface of the weld face 82, 86 or a series of recessed circular grooves that intrude into a base surface of the weld face 83, 86. Such oxide-disrupting features are quite useful when pressed against the aluminum workpiece surface 26 since the ridges/grooves function to stretch and breakdown the refractory oxide surface layer that typically coats an aluminum substrate to establish better electrical, thermal, and mechanical contact at the electrode/workpiece junction. The same electrode weld face design is also able to function effectively when pressed against the steel workpiece surface 28 primarily due to its convex domed shape. The ridges/grooves have very little effect on the communication of current through the steel workpiece 12 and, in fact, are quickly deformed by the stresses associated with being pressed against a steel workpiece 12 during spot welding.

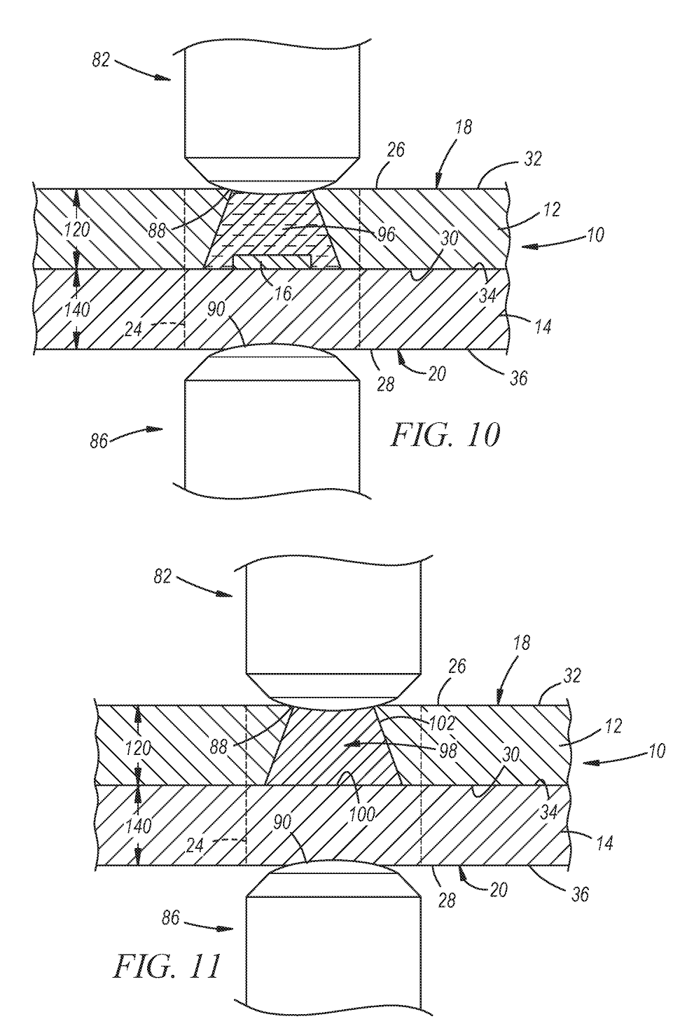

The resistance spot welding method will now be described with reference to FIGS. 10-11, which depict only the aluminum and steel workpieces 12, 14 that overlap and lie adjacent to one another so as to establish the faying interface 22 with the intermediate metallurgical additive 16. The presence of the one or more additional aluminum or steel workpieces in the workpiece stack-up 10 does not affect how the spot welding method is carried out or have any substantial effect on the joining mechanism that takes place between the adjacent pair of aluminum and steel workpieces 12, 14. The more-detailed discussion provided below thus applies equally to instances in which the workpiece stack-up 10 is a “3T” stack-up that includes the additional aluminum workpiece 38 (FIG. 2) or the additional steel workpiece 46 (FIG. 3), as well as the various “4T” stack-ups that may be welded, despite the fact that those additional workpieces are not illustrated in the Figures.

At the onset of the resistance spot welding method, which is depicted in FIG. 9, the workpiece stack-up 10 is located between the first welding electrode 82 and the opposed second welding electrode 86. The weld face 88 of the first welding electrode 82 is positioned to contact the aluminum workpiece surface 26 of the first side 18 of the stack-up 10 and the weld face 90 of the second welding electrode 86 is positioned to contact the steel workpiece surface 28 of the second side 20. The weld gun is then operated to converge the first and second welding electrodes 82, 88 relative to one another so that their respective weld faces 88, 90 make contact with and are pressed against the opposite first and second sides 18, 20 of the stack-up 10 at the welding zone 24. The weld faces 88, 90 are typically facially aligned with each other at the welding zone 24 and impose a clamping force on the workpiece stack-up 10 that preferably ranges from 400 lb (pounds force) to 2000 lb or, more narrowly, from 600 lb to 1300 lb.

After the weld faces 88, 90 of first and second welding electrodes 82, 86 are pressed against the first and second sides 18, 20 of the workpiece stack-up 10, respectively, with an imposed clamping force, electrical current is passed between the facially aligned weld faces 88, 90. The electrical current exchanged between the weld faces 88, 90 is preferably a DC current delivered by a power supply 92 (FIG. 9) which, here, is a medium-frequency direct current (MFDC) inverter power supply that includes an inverter and a MFDC transformer. A MFDC transformer can be obtained commercially from a number of suppliers including Roman Manufacturing (Grand Rapids, Mich.), ARO Welding Technologies (Chesterfield Township, Mich.), and Bosch Rexroth (Charlotte, N.C.). The characteristics of the delivered electrical current are controlled by the weld controller 94. Specifically, the weld controller 94 allows a user to program a weld schedule that sets the waveform of the electrical current being exchanged between the welding electrodes 82, 86.

The electrical current exchanged between the welding electrodes 82, 86 passes through the workpiece stack-up 10 at the welding zone 24 and across the faying interface 22 established between the adjacent aluminum and steel workpieces 12, 14 along with the intermediate metallurgical additive 16. The schedule of the applied welding current may be in the nature of the multi-step schedules disclosed in US2015/0053655 and U.S. Ser. No. 14/883,249 (filed on Oct. 14, 2015), the entire contents of each of those applications begin incorporated herein by reference, or another weld schedule that is suitable for the specific stack-up 10 of the aluminum and steel workpieces 12, 14. Resistance to the flow of electrical current rapidly generates heat within more electrically and thermally resistive steel workpiece, which eventually melts the adjacent aluminum workpiece 12 to create a molten aluminum weld pool 96 within the aluminum workpiece 12, as depicted in FIG. 10. The molten aluminum weld pool 96 extends into the aluminum workpiece 12 away from the faying surface 34 of the steel workpiece 12. The molten aluminum weld pool 96 may penetrate a distance into the aluminum workpiece 12 that ranges from 20% to 100% of the thickness 120 of the aluminum workpiece 12 at the welding zone 24. And, in terms of its composition, the molten aluminum weld pool 96 is composed predominantly of aluminum material derived from the aluminum workpiece 12, although typically some iron (i.e., about 1 wt % or less) dissolves into the weld pool 96 from the steel workpiece 14.

As previously mentioned, the intermediate metallurgical additive 16 may have been initially adhered to either the faying surface 30 of the aluminum workpiece 12 or the faying surface 34 of the steel workpiece 14. In the former case, the heat generated in the intermediate metallurgical additive 16 by the passing electrical current, as well as the heat conducted from the steel workpiece 14 and the molten aluminum weld pool 96, allows for suspension and movement of the intermediate metallurgical additive 16 within the molten weld pool 96. The molten aluminum weld pool 96, in turn, wets the faying surface 34 of the steel workpiece 12 at a temperature that would ordinarily begin to form a layer of Fe—Al intermetallic compounds against the steel workpiece 12 due to a reaction between the molten aluminum and iron from the steel workpiece 14. The added carbon, silicon, nickel, manganese, chromium and/or cobalt content derived from the intermediate metallurgical additive 16, however, changes the composition of the molten aluminum weld pool 96 in a way that counteracts the growth and formation of a layer of Fe—Al intermetallic compounds. Specifically, as discussed above, each of silicon, nickel, manganese, chromium, and cobalt acts as Fe—Al intermetallic compound inhibitors when exposed to the molten aluminum weld pool 96, and each of nickel and copper promotes the formation of Ni—Al and Cu—Al intermetallic compounds, respectively, while suppressing the formation of Fe—Al intermetallic compounds.

In the case where the intermediate metallurgical additive 16 is initially metallurgically bonded to the faying surface 34 of the steel workpiece 14, as shown, the metallurgical additive 16 generally remains in place against the faying surface 34 of the steel workpiece 14 due to its relatively high melting point and, consequently, does not drift away into the molten aluminum weld pool 96. In this way, the molten aluminum weld pool 96 flows over and around the intermediate metallurgical additive 16, or entirely wets the intermediate metallurgical additive 16 if the additive 16 is large enough in diameter. The intermediate metallurgical additive 16 thus functions as a base of modified composition that either retards growth of a layer of Fe—Al intermetallic compounds or changes the nature and composition of the intermetallic layer, e.g., by promoting Ni—Al and/or Cu—Al intermetallic compounds and suppressing Fe—Al intermetallic compounds, in basically the same ways as previously mentioned although, here, the additive 16 is retained at the faying surface 34 of the steel workpiece 14 where the growth and formation of intermetallic compounds is occurring.

The molten aluminum weld pool 96 solidifies into a weld joint 98 after the passage of electrical current between the first and second welding electrodes 82, 86 is terminated, as shown in FIG. 11. The weld joint 98 is comprised mainly of resolidified aluminum and forms a bonding interface 100 with the faying surface 34 of the steel workpiece 14 and/or a surface of the intermediate metallurgical additive 16. The weld joint 98 also forms a workpiece interface 102 that extends away from the bonding interface 100 in narrowing fashion and constitutes the boundary of the weld joint 98 within the aluminum workpiece 12. The internal workpiece interface 102 separates the weld joint 98 from a surrounding heat-affected zone within the aluminum workpiece 12 and extends into the aluminum workpiece 12 to a distance that often ranges from 20% to 100% of the thickness 120 of the aluminum workpiece 12 at the welding zone 24, just like the pre-existing molten aluminum weld pool 96. And, in those instances in which the weld joint 98 fully penetrates the aluminum workpiece 12, as illustrated here in FIG. 11, a portion of the internal workpiece interface 102 is coterminous with a portion of the exposed back surface 32 (or extends past the opposed faying surface 40 if one or more additional aluminum workpieces are included in the stack-up 10) of the aluminum workpiece 12.

The bonding interface 100 establishes the weld bond that secures the aluminum and steel workpieces 12, 14 together within the workpiece stack-up 10. The bonding interface 100 preferably has a surface area that ranges from 4πt to 20πt, in which the variable “t” is the thickness 120 of the aluminum workpiece 120 within the welding zone 24 prior to current flow, in order to attain good joint properties. The attainment of good strength properties—most notably good peel and cross-tension strength properties—is possible through practice of the disclosed method since provisions are made to counter the growth of a hard and brittle Fe—Al intermetallic layer at the boding interface 100. Indeed, under conventional spot welding conditions where the intermediate metallurgical additive 16 is not present, a Fe—Al intermetallic layer having a thickness of approximately 1 μm to 10 μm, with the majority of the layer being above 3 μm, would be expected at the bonding interface 100 contiguous with the faying surface 34 of the steel workpiece 14. But, when the disclosed method is practiced, the resultant bonding interface 100 may include a Fe—Al intermetallic layer having a thickness of approximately 0.5 μm to 3 μm, or no Fe—Al intermetallic layer at all, and may even include a layer that includes Ni—Al intermetallic compounds and/or Cu—Al intermetallic compounds together with or in lieu of Fe—Al intermetallic compounds, which toughens the weld joint 98 at the bonding interface 100 to ultimately enhance the peel and cross-tension strength of the joint 98.

The above description of preferred exemplary embodiments is merely descriptive in nature; they are not intended to limit the scope of the claims that follow. Each of the terms used in the appended claims should be given its ordinary and customary meaning unless specifically and unambiguously stated otherwise in the specification.

1. A method of resistance spot welding a workpiece stack-up that that includes an aluminum workpiece and an adjacent overlapping steel workpiece, the method comprising:
assembling a workpiece stack-up that includes an aluminum workpiece and an overlapping adjacent steel workpiece in which a faying surface of the aluminum workpiece and a faying surface of the steel workpiece confront to establish a faying interface of the aluminum and steel workpieces, the workpiece stack-up further comprising an intermediate metallurgical additive positioned between the faying surfaces of the aluminum and steel workpieces, the intermediate metallurgical additive comprising at least one of carbon, silicon, nickel, manganese, chromium, cobalt, or copper;
pressing a weld face of a first welding electrode against an aluminum workpiece surface that provides a first side of the workpiece stack-up;
pressing a weld face of a second welding electrode against a steel workpiece surface that provides a second side of the workpiece stack-up;
passing an electrical current through the workpiece stack-up and between the weld faces of the first and second welding electrodes to create a molten aluminum weld pool within the workpiece stack-up, the molten aluminum weld pool being exposed to the intermediate metallurgical additive so as to counteract growth and formation of Fe—Al intermetallic compounds within the molten aluminum weld pool; and
terminating passage of the electrical current to allow the molten aluminum weld pool to solidify into a weld joint that weld bonds the aluminum and steel workpieces together.

2. The method set forth in claim 1, wherein the intermediate metallurgical additive is a ferrous alloy that includes at least one of carbon, silicon, nickel, manganese, chromium, cobalt, or copper.

3. The method set forth in claim 3, wherein the intermediate metallurgical additive is a ferrous alloy that includes at least one of 0.050 wt % carbon to 1.0 wt % carbon, 0.1 wt % to 10 wt % silicon, 0.5 wt % to 20 wt % nickel, 0.5 wt % to 30 wt % manganese, 0.5 wt % to 20 wt % chromium, or 0.5 wt % to 50 wt % cobalt.

4. The method set forth in claim 1, wherein the intermediate metallurgical additive is unalloyed nickel, unalloyed copper, or an alloy rich in nickel or copper.

5. The method set forth in claim 4, wherein a layer of intermetallic compounds is produced at a bonding interface of the weld joint and the faying surface of the steel workpiece or a surface of the intermediate metallurgical additive, the layer of intermetallic compounds including Ni—Al intermetallic compounds or Cu—Al intermetallic compounds.

6. The method set forth in claim 1, wherein the intermediate metallurgical additive comprises one or more metallurgical additive deposits deposited onto the faying surface of the aluminum workpiece or the faying surface of the steel workpiece by oscillation wire arc welding.

7. The method set forth in claim 6, wherein depositing each of the one or more metallurgical additive deposits onto the faying surface of the aluminum workpiece or the faying surface of the steel workpiece comprises:
(a) bringing a leading tip end of a consumable electrode rod, which is comprised of a metallurgical additive composition, into contact with the faying surface of the aluminum workpiece or the faying surface of steel workpiece;
(b) passing an electrical current through the consumable electrode rod while the leading tip end of the consumable electrode rod is in contact with the faying surface of the aluminum workpiece or the faying surface of the steel workpiece;
(c) retracting the consumable electrode rod away from the faying surface of the aluminum workpiece or the faying surface of the steel workpiece to thereby strike an arc across a gap formed between the consumable electrode rod and the faying surface of the aluminum workpiece or the faying surface of the steel workpiece, the arc initiating melting of the leading tip end of the consumable electrode rod;
(d) protracting the consumable electrode rod forward to close the gap and bring a molten metallurgical additive droplet that has formed at the leading tip end of the electrode rod into contact with the faying surface of the aluminum workpiece or the faying surface of the steel workpiece, the contact between the molten metallurgical additive droplet and the faying surface of the aluminum workpiece or the faying surface of the steel workpiece extinguishing the arc; and
(e) retracting the consumable electrode rod away from the faying surface of the aluminum workpiece or the faying surface of the steel workpiece to transfer the molten metallurgical additive droplet from the leading tip end of the consumable electrode rod to the faying surface of the aluminum workpiece or the faying surface of the steel workpiece, the molten metallurgical additive droplet transferred to the faying surface of the aluminum workpiece or the faying surface of the steel workpiece solidifying into all or part of a metallurgical additive deposit.

8. The method set forth in claim 7, further comprising:
repeating steps (a) to (e) one or more times to transfer multiple metallurgical additive droplets to the faying surface of the aluminum workpiece or the faying surface of the steel workpiece such that the multiple metallurgical additive droplets combine and solidify into the metallurgical additive deposit.

9. The method set forth in claim 1, wherein the aluminum workpiece includes an exposed back surface that constitutes the aluminum workpiece surface that provides the first side of the workpiece stack-up, and wherein the steel workpiece includes an exposed back surface that constitutes the steel workpiece surface that provides the second side of the workpiece stack-up.

10. The method set forth in claim 1, wherein the workpiece stack-up includes at least one of: (1) an additional aluminum workpiece that overlaps the aluminum and steel workpieces and lies adjacent to the aluminum workpiece or (2) an additional steel workpiece that overlaps the aluminum and steel workpieces and lies adjacent to the steel workpiece.

11. The method set forth in claim 1, wherein a layer of intermetallic compounds is produced at a bonding interface of the weld joint and the faying surface of the steel workpiece or a surface of the intermediate metallurgical additive, the layer of intermetallic compounds including Fe—Al intermetallic compounds and being less than 3 μm in thickness.

12. The method set forth in claim 1, wherein the aluminum workpiece includes an aluminum substrate composed of an aluminum alloy having a refractory oxide surface layer and the steel workpiece includes a coated or uncoated steel substrate composed of mild steel, dual phase steel, or boron steel.

13. A method of resistance spot welding a workpiece stack-up that that includes an aluminum workpiece and an adjacent overlapping steel workpiece, the method comprising:
depositing a metallurgical additive deposit onto a faying surface of an aluminum workpiece such that the metallurgical additive deposit is adhered to the faying surface of the aluminum workpiece, the metallurgical additive deposit being a metal that comprises at least one of carbon, silicon, nickel, manganese, chromium, cobalt, or copper;
assembling the aluminum workpiece into a workpiece stack-up along with a steel workpiece such that the workpiece stack-up includes the aluminum workpiece and the steel workpiece arranged in overlapping fashion with the metallurgical additive deposit being located between the faying surface of the aluminum workpiece and a faying surface of the steel workpiece;
pressing a weld face of a first welding electrode against an aluminum workpiece surface that provides a first side of the workpiece stack-up;
pressing a weld face of a second welding electrode against a steel workpiece surface that provides a second side of the workpiece stack-up; and
passing an electrical current through the workpiece stack-up and between the weld faces of the first and second welding electrodes to create a molten aluminum weld pool within the workpiece stack-up, the molten aluminum weld pool wetting the faying surface of the steel workpiece and having the metallurgical additive deposit suspended therein to counteract growth and formation of Fe—Al intermetallic compounds against the faying surface of the steel workpiece; and
terminating passage of the electrical current to allow the molten aluminum weld pool to solidify into a weld joint that weld bonds the aluminum and steel workpieces together.

14. The method set forth in claim 12, wherein the metallurgical additive deposit is a ferrous alloy that includes at least one of 0.050 wt % to 1.0 wt % carbon, 0.1 wt % to 10 wt % silicon, 0.5 wt % to 20 wt % nickel, 0.5 wt % to 30 wt % manganese, 0.5 wt % to 20 wt % chromium, or 0.5 wt % to 50 wt % cobalt.

15. The method set forth in claim 12, wherein the metallurgical additive deposit is unalloyed nickel, unalloyed copper, or an alloy rich in nickel or copper.

16. The method set forth in claim 12, wherein the metallurgical additive deposit is deposited onto the faying surface of the aluminum workpiece by oscillation wire arc welding.

17. A method of resistance spot welding a workpiece stack-up that that includes an aluminum workpiece and an adjacent overlapping steel workpiece, the method comprising:
depositing a metallurgical additive deposit onto a faying surface of a steel workpiece such that the metallurgical additive deposit is adhered to the faying surface of the steel workpiece, the metallurgical additive deposit being a metal that comprises at least one of carbon, silicon, nickel, manganese, chromium, cobalt, or copper;
assembling the steel workpiece into a workpiece stack-up along with an aluminum workpiece such that the workpiece stack-up includes the steel workpiece and the aluminum workpiece arranged in overlapping fashion with the metallurgical additive deposit being located between the faying surface of the steel workpiece and a faying surface of the aluminum workpiece;
pressing a weld face of a first welding electrode against an aluminum workpiece surface that provides a first side of the workpiece stack-up;
pressing a weld face of a second welding electrode against a steel workpiece surface that provides a second side of the workpiece stack-up; and
passing an electrical current through the workpiece stack-up and between the weld faces of the first and second welding electrodes to create a molten aluminum weld pool within the workpiece stack-up, the molten aluminum weld pool wetting a surface of the metallurgical additive deposit and, if available, the faying surface of the steel workpiece to counteract growth and formation of Fe—Al intermetallic compounds against the faying surface of the steel workpiece; and
terminating passage of the electrical current to allow the molten aluminum weld pool to solidify into a weld joint that weld bonds the aluminum and steel workpieces together.

18. The method set forth in claim 17, wherein the metallurgical additive deposit is a ferrous alloy that includes at least one of 0.050 wt % to 1.0 wt % carbon, 0.1 wt % to 10 wt % silicon, 0.5 wt % to 20 wt % nickel, 0.5 wt % to 30 wt % manganese, 0.5 wt % to 20 wt % chromium, or 0.5 wt % to 50 wt % cobalt.

19. The method set forth in claim 17, wherein the metallurgical additive deposit is unalloyed nickel, unalloyed copper, or an alloy rich in nickel or copper.

20. The method set forth in claim 17, wherein the metallurgical additive deposit is deposited onto the faying surface of the steel workpiece by oscillation wire arc welding.
